(19) United States
(12) Patent Application Publication
(10) Pub. No.: US 2009/0268593 A1
(43) Pub. Date: Oct. 29, 2009

(54) Information recording medium, information recording apparatus and method, information reproducing apparatus and method, and computer program

(76) Inventors: Kazuo Kuroda, Tokorozawa-shi (JP); Masahiro Kato, Tokorozawa-shi (JP)

Correspondence Address: YOUNG & THOMPSON, 209 Madison Street, Suite 500, ALEXANDRIA, VA, 22314, US

(21) Appl. No.: 11/991,177

(22) PCT Filed: Aug. 30, 2006
(86) PCT No.: PCT/JP2006/317058

§ 371 Date: Apr. 29, 2008

(30) Foreign Application Priority Data
Aug. 30, 2005 (JP) 2005-249588

(51) Int. Cl. G11B 7/24

(52) U.S. Cl. 369/275.3; G9B/7

(57) ABSTRACT

An information recording medium (100) comprising (i) a first recording layer (layer L0) in which a first part of record data can be recorded and which has such a characteristic that the number of times of possibly rewriting the record data per unit area corresponds to a first number of times; and (ii) a second recording layer (layer L1) in which a second part of the record data can be recorded by use of a laser beam having passed through the first recording layer and which has such a characteristic that the number of times of possibly rewriting the record data per unit area corresponds to a second number of times; wherein frequently rewritten information (FS1), which is relatively frequently rewritten, can be recorded at least in the second recording layer

### TECHNICAL FIELD

The present invention relates to an information recording medium, such as an optical disc, like a DVD (Digital Versatile Disc), a BD (Blu-ray Disc), a CD (Compact Disc) or the like, on which recoding and reproduction can be performed by irradiating it with laser light, a recording apparatus and a recording method for the information recording medium, a reproducing apparatus and a reproducing method, a recording/reproducing apparatus and a recording/reproducing method, and a computer program.

### BACKGROUND ART

In an information recording medium of a recording type, such as a CD-R (Compact Disc-Recordable), a DVD-R, a DVD-RW, and a DVD+R, for example, as described in patent documents 1 and 2, etc., there is also developed an information recording medium, such as an optical disc, of a multilayer type or dual layer type or multiple layer type, in which a plurality of recording layers are laminated or stacked on the same substrate. Then, on an information recording apparatus, such as a DVD recorder, which performs recording with respect to the dual layer type, i.e., two-layer type optical disc, information is recorded in an irreversible change recording method by heat or the like, or in a rewritable method, into a recording layer located on the front (i.e. on the closer side to an optical pickup) viewed from a laser light irradiation side (hereinafter referred to as an “L0 layer”, as occasion demands), by focusing the laser light for recording on the L0 layer. On the other hand, information is recorded in the irreversible change recording method by heat or the like, or in the rewritable method, into a recording layer located on the rear (i.e. on the farther side to the optical pickup) viewed from the laser light irradiation side (hereinafter referred to as an “L1 layer”, as occasion demands), by focusing the laser light for recording on the L1 layer through the L0 layer.

Patent document 1: Japanese Patent Application Laid Open NO. 2000-311346
Patent document 2: Japanese Patent Application Laid Open NO. 2001-23237
Patent document 3: Japanese Patent Application Laid Open NO. 2005-71468

### DISCLOSURE OF INVENTION

### Subject to be Solved by the Invention

However, for example, in the recording type information recording medium provided with the plurality of recording layers described above, when record data is recorded into one of the plurality of recording layers, it is not considered a quantitative or qualitative relationship between (i) the frequency of rewriting (or the number of rewriting times) determined on the basis of a logical attribute and characteristics, as a target of a software program and an application, in the record data and (ii) the number of rewriting times determined on the basis of physical properties of the one kind of recording layer in which the record data is supposed to be recorded. Thus, in the actual recording of the record data, there is such a technical problem that it is hard to approach, for example, the number of rewriting times determined on the basis of physical features, which causes a non-effective use in the recording area of the information recording medium.

It is therefore an object of the present invention to provide an information recording medium, an information recording apparatus, an information recording method, an information reproducing apparatus, and an information reproducing method, which enable more efficient recording and reduction of the record data on e.g. a multilayer recording type information recording medium, and a computer program which makes a computer function as the information recording apparatus and the information reproducing apparatus described above.

### Means for Solving the Subject

(Information Recording Medium)

Hereinafter, the information recording medium of the present invention will be explained.

The above object of the present invention can be achieved by an information recording medium, at least provided with: a first recording layer (or L0 layer) in which a first portion of record data can be recorded and which has such a property that a limit frequency of rewriting the record data (or the number of rewriting times of the record data) per unit area of a recording area (e.g. an entire recording area over a L0 layer and a L1 layer) corresponds to a first frequency or a first number of times (e.g. 2000 times); and a second recording layer (or L1 layer) in which a second portion of the record data can be recorded by using laser light transmitted through the first recording layer and which has such a property that a limit frequency of rewriting the record data (or the number of rewriting times of the record data) per unit area of the recording area corresponds to a second frequency or a second number of times (e.g. 10,000 times), which is greater than the first frequency or the first number of times, wherein rewriting-high-frequent information of the record data, whose frequency of rewriting is relatively higher than the frequency of rewriting of the record data (or wherein rewriting-high-frequent information of the record data, whose number of rewriting times is relatively high), can be recorded at least into the second recording layer.

According to the information recording medium of the present invention, for example, in the first recording layer, such as the L0 layer, the first portion of the record data can be recorded. In addition to this, in the first recording layer, for example, the frequency of rewriting (or the frequency of rewriting times or the number of rewriting times) of the record data per unit area of the recording area over the L0 layer and the L1 layer is the first number of times (e.g. 2,000 times), in association with the property held in the first recording layer. Incidentally, since the first number of times depends on the properties of the information recording medium and the recording power of an information recording apparatus, the first number of times is not limited to 2,000 times. For example, it may be an arbitrary number of times, such as 1,000 times or 800 times.

On the other hand, for example, in the second recording layer, such as the L1 layer, the second portion of the record data can be recorded. In addition to this, in the second recording layer, for example, the number of rewriting times of the record data per unit area of the recording area over the L0 layer and the L1 layer is the second number of times (e.g. 10,000 times), which is greater than the first number of times, in association with the property held in the second recording layer.

In particular, in the present invention, focusing on the second recording layer in which the number of rewriting times is greater than that in the first recording layer, there is provided the information whose number of rewriting times is relatively high. In other words, focusing on the first recording layer in which the number of rewriting times is less than that in the second recording layer, there is provided the information whose number of rewriting times is relatively low. Therefore, by efficiently providing the record data, whose number of rewriting times can be predicted in advance, in the first recording layer or the second recording layer, it is possible to increase the number of rewriting times in the entire recording area of the information recording medium.

That is, in the present invention, the rewriting-high-frequent information of the record data, whose frequency of rewriting is relatively higher than the frequency of rewriting of the record data (or the rewriting-high-frequent information of the record data, whose number of rewriting times is relatively high), can be recorded at least into the second recording layer which has such a property that the number of rewriting times of the record data per unit area of the recording area is relatively high, corresponds to the second number of times. In other words, a quantitatively and qualitatively preferable correlation can be maintained between (i) the number of rewriting times determined on the basis of a logical attribute and characteristics, as the target of the software program and the application or as the control information, such as a file system, in the record data and (ii) the number of rewriting times determined on the basis of the physical properties in the first or second recording layer in which the record data is supposed to be recorded. Therefore, it is possible to record the record data into the more preferable recording layer, more efficiently. Consequently, for example, the number of times of actually recording the record data into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

In one aspect of the information recording medium of the present invention, the rewriting-high-frequent information can be rewritten by the number of rewriting times which is greater than the first frequency or the first number of times.

According to this aspect, the rewriting-high-frequent information, whose number of rewriting times is greater than the first number of times, can be more properly recorded into the second recording layer.

In another aspect of the information recording medium of the present invention, control information (File System) for controlling a recording order or reproduction order of the record data can be recorded into the second recording layer, as the rewriting-high-frequent information.

According to this aspect, for example, the second recording layer is firstly accessed by an information recording/reproducing apparatus described later. Then, the control information, such as a file system, for controlling the recording or reproducing order of the record data can be obtained by a series of obtaining process following the initial operation of a recording or reproducing process, quickly and accurately.

In an aspect associated with the control information, the control information (File System) includes information about directory, which logically hierarchically indicates a position of the record data recorded in the recording area.

According to this aspect, among the control information, (such as a file system,) the information about directory, whose rewriting frequency is relatively higher, can be recorded in the second recording layer in a preferable correlation with the information about directory.

In an aspect associated with the control information, the control information (File System) includes pointer information, which indicates a position of an end edge (Anchor Point) of the record data recorded in the recording area.

According to this aspect, among the control information, (such as a file system,) the pointer information, whose rewriting frequency is relatively higher, can be recorded in the second recording layer in a preferable correlation with the pointer information.

In an aspect associated with the control information, the control information (File System) can be recorded into a control information recording area, which is located on an inner circumferential side (Opposite) or outer circumferential side (Parallel), adjacent to a position of an end edge of the record data recorded in the second recording layer.

According to this aspect, for example, by a series of process following the recording or reproducing process on the information recording/reproducing apparatus, it is possible to perform the rewriting or additional recording of the control information, such as a file system, quickly and accurately, in respond to a change in the data amount of the control information.

In another aspect of the information recording medium of the present invention, control information (File System) for controlling a recording order or reproduction order of the record data can be recorded in a control information recording area with a predetermined recording capacity, in the second recording layer, as the rewriting-high-frequent information.

According to this aspect, by recording the control information, such as a file system, into the control information recording area with a predetermined recording capacity, it is possible to use the recording area of the second recording layer, more efficiently, while limiting the recording area in which the control information is recorded.

In another aspect of the information recording medium of the present invention, rewriting-low-frequent information of the record data, whose number of rewriting times is relatively low, can be recorded into the first recording layer.

According to this aspect, since the rewriting-low-frequent information is recorded into the first recording layer, a quantitatively and qualitatively preferable correlation can be maintained between (i) the number of rewriting times determined on the basis of the logical attribute and characteristics in the record data and (ii) the number of rewriting times determined on the basis of the physical properties in the first or second recording layer in which the record data is supposed to be recorded. Therefore, it is possible to record the record data including the rewriting-low-frequent information into the more preferable recording layer, more efficiently.

In another aspect of the information recording medium of the present invention, the rewriting-low-frequent information can be rewritten by the number of rewriting times which is less than the first frequency or the first number of times.

According to this aspect, the rewriting-low-frequent information, whose number of rewriting times is less than the first number of times, can be more properly recorded into the first recording layer.

In another aspect of the information recording medium of the present invention, rewriting-low-frequent information of the record data, whose number of rewriting times is relatively low, can be recorded in advance in the first recording layer, by formation of embossed pits.

According to this aspect, for example, it is possible to simplify the recording of the rewriting-low-frequent information, whose rewriting frequency is relatively low or whose rewriting is hardly or not performed at all. In addition, for example, eliminating the oscillation or wobble of embossed pits allows incorrect overwriting to be prevented, so that it is possible to protect the rewriting-low-frequent information, whose rewriting frequency is relatively low or whose rewriting is hardly or not performed at all.

In another aspect of the information recording medium of the present invention, of control information (File System) for controlling a recording order or reproduction order of the record data, attribute information or an entry point can be recorded into the first recording layer, the attribute information indicating an attribute of the control information, the entry point indicating a position of a start edge of the record data recorded in the recording area by using a logical or physical address.

According to this aspect, for example, if the first recording layer is accessed by the information recording/reproducing apparatus, versatile information, such as attribute information and the entry point, included in the control information can be obtained quickly and accurately.

In another aspect of the information recording medium of the present invention, it is further provided with a management area (RMD/CDZ) in which identification information (flag) can be recorded, wherein the identification information indicates whether or not control information (File System) for controlling a recording order or reproduction order of the record data is recorded into the second recording layer.

According to this aspect, for example, the information recording/reproducing apparatus can judge whether or not the control information is recorded in the second recording layer of the optical disc, which is a recording or reproduction target, to thereby quickly and accurately perform the recording or reproduction on the information recording medium.

In another aspect of the information recording medium of the present invention, control information (File System) for controlling a recording order or reproduction order of the record data includes management information for logically continuously recording or reproducing one portion of the control information, which is recorded in the first recording layer, and another portion of the control information, which is recorded in the second recording layer.

According to this aspect, for example, even if the control information, such as a file system, is recorded by the information recording/reproducing apparatus in the first recording layer in addition to the second recording layer, the control information recorded in both the first recording layer and the second recording layer, is obtained on the basis of the management information, quickly and accurately.

In another aspect of the information recording medium of the present invention, a layer thickness of the second recording layer is greater than a layer thickness of the first recording layer.

According to this aspect, it is possible to relatively increase the number of rewriting times of the record data per unit area of the recording area in the second recording layer, on the basis of the layer thicknesses or the film thicknesses of the first and second recording layers.

In another aspect of the information recording medium of the present invention, the first recording layer has a first reflective layer, the second recording layer has a second reflective layer, and a layer thickness or film thickness of the second reflective layer is greater than a layer thickness or film thickness of the first reflective layer.

According to this aspect, it is possible to relatively increase the number of rewriting times of the record data per unit area of the recording area in the second recording layer, on the basis of the layer thickness or the film thicknesses of the first and second reflective layers.

(Information Recording Apparatus)

Hereinafter, the information recording apparatus of the present invention will be explained.

The above object of the present invention can be also achieved by an information recording apparatus for recording record data onto an information recording medium, at least provided with: a first recording layer (or L0 layer) in which a first portion of the record data can be recorded and which has such a property that the limit frequency of rewriting the record data (or the number of rewriting times of the record data) per unit area of a recording area (e.g. an entire recording area over a L0 layer and a L1 layer) corresponds to a first frequency or a first number of times (e.g. 2,000 times); and a second recording layer (or L1 layer) in which a second portion of the record data can be recorded by using laser light transmitted through the first recording layer and which has such a property that the limit frequency of rewriting the record data (or the number of rewriting times of the record data) per unit area of the recording area corresponds to a second frequency or a second number of times (e.g. 10,000 times), which is greater than the first frequency or the first number of times, wherein one portion of control information (File System), (i) whose number of rewriting times is relatively high out of the record information and (ii) which controls a recording order or reproduction order of the record data, can be recorded into the second recording layer, the information recording apparatus provided with: an obtaining device for obtaining the control information; a recording device for recording the record data or the control information; and a controlling device for (iii) controlling the recording device to record the record data on the basis of the obtained control information and (iv) controlling the recording device to record the control information in order to update the control information on the basis of the recording of the record data.

According to the information recording apparatus of the present invention, firstly, the control information for controlling the recording order or reproduction order of the record data is obtained by the obtaining device, such as an optical pickup. Then, for example, the record data is recorded on the basis of the obtained control data, by the recording device, such as an optical pickup, under the control of the controlling device, such as a CPU (Central Processing Unit) of a drive or a host computer.

In particular, in the present invention, the control information of the record data, whose number of rewriting times is relatively high, can be recorded at least into the second recording layer which has such a property that the number of rewriting times of the record data per unit area of the recording area corresponds to the second number of times, which is relatively high, by the recording device, under the control of the controlling device. In other words, the control information can be recorded so as to maintain a quantitatively and qualitatively preferable correlation between (i) the number of rewriting times determined on the basis of the logical attribute and characteristics, as the target of the software program and the application or as the control information, such as a file system, in the record data and (ii) the number of rewriting times determined on the basis of the physical properties in the first or second recording layer in which the record data is supposed to be recorded. Therefore, it is possible to record the control information into the more preferable recording layer, more efficiently. Consequently, for example, the number of times of actually recording the record data including the control information into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

Incidentally, in response to the various aspects owned by the aforementioned information recording medium of the present invention, the information recording apparatus of the present invention can employ various aspects.

(Information Reproducing Apparatus)

Hereinafter, the information reproducing apparatus of the present invention will be explained.

The above object of the present invention can be also achieved by information reproducing apparatus for reproducing record data from an information recording medium, at least provided with: a first recording layer (or L0 layer) in which a first portion of the record data can be recorded and which has such a property that the limit frequency of rewriting the record data (or the number of rewriting times of the record data) per unit area of a recording area (e.g. an entire recording area over a L0 layer and a L1 layer) corresponds to a first frequency or a first number of times (e.g. 2,000 times); and a second recording layer (or L1 layer) in which a second portion of the record data can be recorded by using laser light transmitted through the first recording layer and which has such a property that the limit frequency of rewriting the record data (or the number of rewriting times of the record data) per unit area of the recording area corresponds to a second frequency or a second number of times (e.g. 10,000 times), which is greater than the first frequency or the first number of times, wherein one portion of control information (File System), (i) whose number of rewriting times is relatively high out of the record information and (ii) which controls a recording order or reproduction order of the record data, can be recorded into the second recording layer, the information reproducing apparatus provided with: an obtaining device for obtaining the control information; a reproducing device for reproducing the record data or the control information; and a controlling device for (iii) controlling the reproducing device to reproduce the record data on the basis of the obtained control information.

According to the information reproducing apparatus of the present invention, firstly, the control information for controlling the recording order or reproduction order of the record data is obtained by the obtaining device, such as an optical pickup. Then, for example, the record data is reproduced on the basis of the obtained control data, by the reproducing device, such as an optical pickup, under the control of the controlling device, such as a CPU (Central Processing Unit) of a drive or a host computer.

In particular, in the present invention, the control information has the relatively high number of rewriting times out of the record data, and the control information is recorded at least into the second recording layer which has such a property that the number of rewriting times of the record data per unit area of the recording area corresponds to the second number of times, which is relatively high. In other words, the control information is recorded so as to maintain a quantitatively and qualitatively preferable correlation between (i) the number of rewriting times determined on the basis of the logical attribute and characteristics, as the target of the software program and the application or as the control information, such as a file system, in the record data and (ii) the number of rewriting times determined on the basis of the physical properties in the first or second recording layer in which the record data is supposed to be recorded. Consequently, it is possible to reproduce the record data on the basis of the control information, which is recorded by taking maximum advantage of the physical properties in the first or second recording layer of the information recording medium to use the recording area in the first or second recording layer, more efficiently.

Incidentally, in response to the various aspects owned by the aforementioned information recording medium of the present invention, the information reproducing apparatus of the present invention can employ various aspects.

(Information Recording Method)

Hereinafter, the information recording method of the present invention will be explained.

The above object of the present invention can be also achieved by an information recording method in an information recording apparatus provided with a recording device for recording record data or control information onto an information recording medium, at least provided with: a first recording layer (or L0 layer) in which a first portion of the record data can be recorded and which has such a property that the limit frequency of rewriting the record data (or the number of rewriting times of the record data) per unit area of a recording area (e.g. an entire recording area over a L0 layer and a L1 layer) corresponds to a first frequency or a first number of times (e.g. 2,000 times); and a second recording layer (or L1 layer) in which a second portion of the record data can be recorded by using laser light transmitted through the first recording layer and which has such a property that the limit frequency of rewriting the record data (or the number of rewriting times of the record data) per unit area of the recording area corresponds to a second frequency or a second number of times, which is greater than the first frequency or the first number of times (e.g. 10,000 times), wherein one portion of the control information (File System), (i) whose number of rewriting times is relatively high out of the record information and (ii) which controls a recording order or reproduction order of the record data, can be recorded into the second recording layer, the information recording method provided with: an obtaining process of obtaining the control information; and a controlling process of (iii) controlling the recording device to record the record data on the basis of the obtained control information and (iv) controlling the recording device to record the control information in order to update the control information on the basis of the recording of the record data.

According to the information recording method of the present invention, it is possible to receive the various benefits owned by the aforementioned information recording apparatus of the present invention.

Incidentally, in response to the various aspects owned by the aforementioned information recording apparatus of the present invention, the information recording method of the present invention can employ various aspects.

(Information Reproducing Method)

Hereinafter, the information reproducing method of the present invention will be explained.

The above object of the present invention can be also achieved by an information reproducing method in an information reproducing apparatus provided with a reproducing device for reproducing record data or control information from an information recording medium, at least provided with: a first recording layer (or L0 layer) in which a first portion of the record data can be recorded and which has such a property that the limit frequency of rewriting the record data (or the number of rewriting times of the record data) per unit area of a recording area (e.g. an entire recording area over a L0 layer and a L1 layer) corresponds to a first frequency or a first number of times (e.g. 2,000 times); and a second recording layer (or L1 layer) in which a second portion of the record data can be recorded by using laser light transmitted through the first recording layer and which has such a property that the limit frequency of rewriting the record data (or the number of rewriting times of the record data) per unit area of the recording area corresponds to a second frequency or a second number of times (e.g. 10,000 times), which is greater than the first frequency or the first number of times, wherein one portion of the control information (File System), (i) whose number of rewriting times is relatively high out of the record information and (ii) which controls a recording order or reproduction order of the record data, can be recorded into the second recording layer, the information reproducing method provided with: an obtaining process of obtaining the control information; and a controlling process of (iii) controlling the reproducing device to reproduce the record data on the basis of the obtained control information

According to the information reproducing method of the present invention, it is possible to receive the various benefits owned by the aforementioned information reproducing apparatus of the present invention.

Incidentally, in response to the various aspects owned by the aforementioned information reproducing apparatus of the present invention, the information reproducing method of the present invention can employ various aspects.

(Computer Program)

Hereinafter, the computer program of the present invention will be explained.

The above object of the present invention can be also achieved by a computer program for recording control to control a computer provided for the aforementioned information recording apparatus of the present invention (including its various aspects), the computer program making the computer function as at least one portion of the obtaining device, the recording device, and the controlling device.

The above object of the present invention can be also achieved by a computer program for reproduction control to control a computer provided for the aforementioned information reproducing apparatus of the present invention (including its various aspects), the computer program making the computer function as at least one portion of the obtaining device, the reproducing device, and the controlling device.

According to each of the computer programs of the present invention, the aforementioned information recording apparatus or information reproducing apparatus of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects owned by the aforementioned information recording apparatus or information reproducing apparatus of the present invention, each computer program of the present invention can employ various aspects.

The above object of the present invention can be also achieved by a first computer program product in a computer-readable medium for tangibly embodying a program of instructions executable by a computer provided in the aforementioned information recording apparatus of the present invention (including its various aspects), to make the computer function as at least one portion of the obtaining device, the recording device, and the controlling device.

The above object of the present invention can be also achieved by a second computer program product in a computer-readable medium for tangibly embodying a program of instructions executable by a computer provided in the aforementioned information reproducing apparatus of the present invention (including its various aspects), to make the computer function, as at least one portion of the obtaining device, the reproducing device, and the controlling device.

According to the first or second computer program product of the present invention, the aforementioned information recording apparatus or information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus or information reproducing apparatus of the present invention.

These effects and other advantages of the present invention will become more apparent from the embodiments explained below.

As explained above, according to the information recording medium of the prevent invention, it is provided with: the first recording layer which has such a property that the limit frequency of rewriting the record data (or the number of rewriting times of the record data) per unit area of the recording area corresponds to the first frequency or the first number of times; and the second recording layer which has such a property that the limit frequency of rewriting the record data (or the number of rewriting times of the record data) per unit area of the recording area corresponds to the second frequency or the second number of times. Consequently, for example, the number of times of actually recording the record data including the control information into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

Moreover, according to the information recording apparatus, it is provided with: the obtaining device; the recording device; and the controlling device. According to the information recording method, it is provided with: the obtaining process; the recording process; and the controlling process. Consequently, for example, the number of times of actually recording the record data including the control information into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

Moreover, according to the information reproducing apparatus, it is provided with: the obtaining device; the reproducing device; and the controlling device. According to the information recording method, it is provided with: the obtaining process; the reproducing process; and the controlling process. Consequently, it is possible to reproduce the record data on the basis of the control information, which is recorded by taking maximum advantage of the physical properties in the recording layer of the information recording medium to use the recording area in the recording layer, more efficiently.

Moreover, according to each of the computer programs of the present invention, it makes a computer function as the aforementioned information recording apparatus or information reproducing apparatus. Thus, in the aforementioned information recording medium, the number of times of actually recording the record data including the control information into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

### BRIEF DESCRIPTION OF DRAWINGS

FIG. 1 are a substantial plan view showing the basic structure of an optical disc having a plurality of types of recording areas in an embodiment of the information recording medium of the present invention (FIG. 1(a)), and a conceptual view showing the structure of the plurality of types of recording areas in the radial direction and associated with the substantial plan view of the optical disc.

FIG. 2 is an enlarged perspective view showing a partially enlarged recording surface, in the optical disc in the embodiment of the information recording medium of the present invention.

FIG. 3 are enlarged cross sectional views showing partially enlarged cut surfaces of recording layers, in the optical disc in the embodiment of the information recording medium of the present invention.

FIG. 4 is a graph conceptually showing the data structure of a dual-layer optical disc in the embodiment of the information recording medium of the present invention, an address, such as a physical sector number which constitutes an ECC block, in the recording area of the optical disc, and a recording or reproducing method by an opposite method in the optical disc.

FIG. 5 is a schematic diagram conceptually showing the basic structure of a UDF, which is one specific example of a file system associated with the control information of the present invention.

FIG. 6 is a schematic diagram conceptually showing the data structure of the UDF, which is one specific example of the file system associated with the control information of the present invention.

FIG. 7 are schematic diagrams (FIG. 7(a) and FIG. 7(b)) conceptually showing two types of anchor points, which constitute the UDF, which is one specific example of the file system associated with the control information of the present invention.

FIG. 8 is a block diagram showing the basic structures of an information recording/reproducing apparatus in an embodiment of the information recording apparatus of the present invention, and a host computer.

FIG. 9 is a flowchart showing a recording process including (i) rewriting or additional recording of file data, such as user data, and (ii) rewriting or additional recording of the file system, such as a UDF, performed by the information recording/reproducing apparatus in the embodiment of the information recording apparatus of the present invention.

FIG. 10 is a schematic diagram conceptually showing the data structure of a dual-layer optical disc in a second embodiment of the information recording medium of the present invention.

FIG. 11 is a schematic diagram conceptually showing the data structure of the dual-layer optical disc in the second embodiment of the information recording medium of the present invention, and a recording or reproducing method by the opposite method in the optical disc.

FIG. 12 is a schematic diagram conceptually showing the data structure of a dual-layer optical disc in a third embodiment of the information recording medium of the present invention.

FIG. 13 is a schematic diagram conceptually showing the data structure of a dual-layer optical disc in a fourth embodiment of the information recording medium of the present invention, and a recording or reproducing method by the opposite method in the optical disc.

FIG. 14 is a schematic diagram conceptually showing the data structure of the dual-layer optical disc in the fourth embodiment of the information recording medium of the present invention, and a recording or reproducing method by a parallel method in the optical disc.

FIG. 15 is a table showing management information including identification information (flag) or the like, which indicates whether or not the file system is recorded in a L1 layer, in a fifth embodiment of the information recording medium of the present invention.

FIG. 16 is a schematic diagram conceptually showing the data structure of a dual-layer optical disc in a sixth embodiment of the information recording medium of the present invention.

### DESCRIPTION OF REFERENCE CODES

1 . . . center hole, 10 . . . track, 11 . . . ECC block, 100 . . . optical disc, 101 . . . lead-in area, 102 . . . data area, 103 . . . lead-out area, 104 . . . middle area, 300 . . . information recording/reproducing apparatus, 301 . . . optical pickup, 302 . . . signal recording/reproducing device, 303 . . . address detector, 305 . . . CPU (drive control device), 306 . . . spindle motor, 307 (402) . . . memory, 308 (406) . . . data input/output control device, 309 (407) . . . bus, 400 . . . host computer, 401 . . . CPU (for host), 403 . . . operation control device, 404 . . . operation button, 405 . . . display panel, CDZ . . . control data zone, RMA . . . recording management area, LB . . . laser light, FS1 (FS0) . . . file system

### BEST MODE FOR CARRYING OUT THE INVENTION

Hereinafter, the best mode for carrying out the present invention will be discussed in order for each embodiment, with reference to the drawings.

### (1) Embodiment of Information Recording Medium

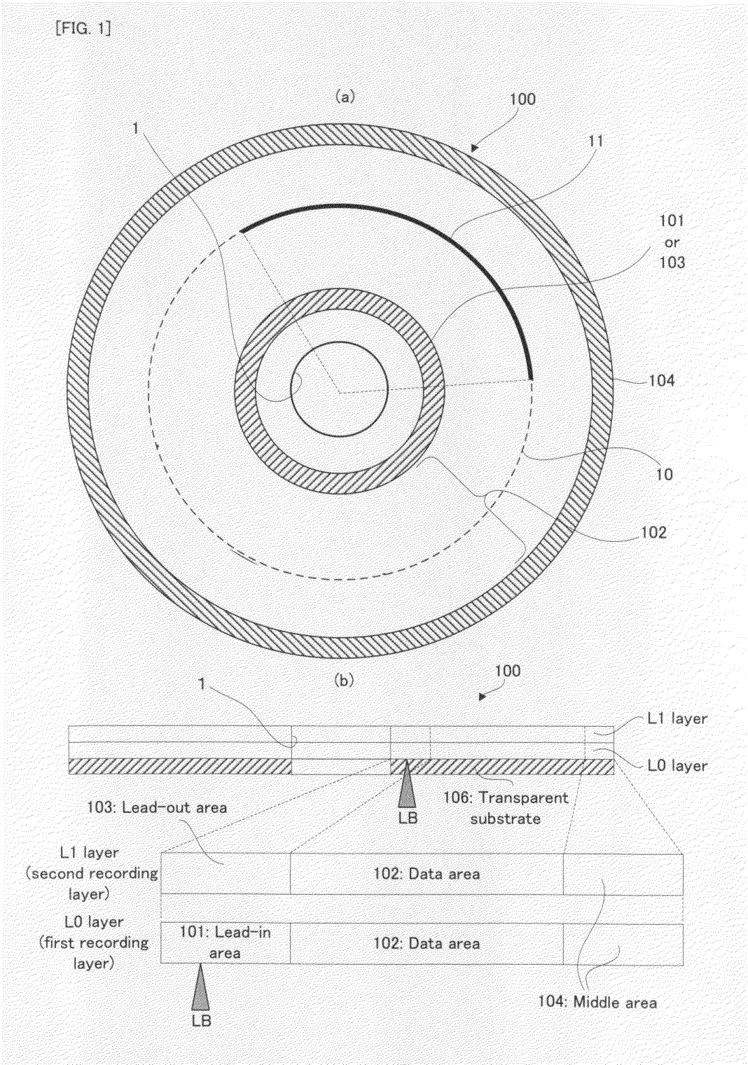

Next, with reference to FIG. 1 to FIG. 7, an information recording medium in an embodiment of the present invention will be discussed in detail.

(1-1) Basic Structure

Firstly, with reference to FIG. 1, the basic structure of an optical disc in the embodiment of the information recording medium of the present invention will be explained. FIG. 1 are a substantial plan view showing the basic structure of the optical disc having a plurality of types of recording areas in the embodiment of the information recording medium of the present invention (FIG. 1(a)), and a conceptual view showing the structure of the plurality of types of recording areas in the radial direction and associated with the substantial plan view of the optical disc.

As shown in FIG. 1(a) and FIG. 1(b), an optical disc 100 has a recording surface on a disc main body with a diameter of about 12 cm, as is a DVD. On the recording surface, the optical disc 100 is provided with: a center hole 1 as the center; a lead-in area 101 or a lead-out area 103; a data area 102; and a middle area 104, which are associated with the embodiment. Then, for example, on a transparent substrate 106 of the optical disc 100, there are laminated recording layers, such as a L0 layer and a L1 layer. In each recording area of the recording layers, a track or tracks 10, such as groove tracks and land tracks, are alternately placed, spirally or concentrically, centered on the center hole 1. On the track 10, data is divided and recorded by a unit of ECC block 11. The ECC block 11 is a data management unit by which record data (or record information) is error-correctable.

Incidentally, the present invention is not particularly limited to the optical disc having these three areas. For example, even if the lead-in area 101, the lead-out area 103 or the middle area 104 does not exist, a data structure explained below can be constructed. Moreover, as described later, the lead-in area 101, the lead-out area 103 or the middle area 104 may be further segmentized.

The optical disc 100 in the embodiment, as shown in FIG. 1(b), has such a structure that the L0 layer and the L1 layer are laminated on the transparent substrate 106, wherein the L0 layer constitutes one example of the first recording layer of the present invention and the L1 layer constitutes one example of the second recording layer of the present invention. Upon the recording/reproduction of such a dual-layer type optical disc 100, the recording/reproduction in the L0 layer or the L1 layer is performed, depending on which recording layer has the focus position of laser light LB, irradiated from the lower side to the upper side in FIG. 1(b). Moreover, the optical disc 100 in the embodiment is not limited to a two-layer single sided type, i.e., a dual layer type, but may be a two-layer double sided type, i.e., a dual layer double sided type. Furthermore, the optical disc 100 in the embodiment is not limited to the optical disc having the two recording layers, as described above, but may be an optical disc of a multilayer type which has three or more layers. Incidentally, a recording/reproducing procedure by an opposite method in the dual-layer type optical disc and the data structure of each layer will be discussed later.

(1-2) Physical Structure

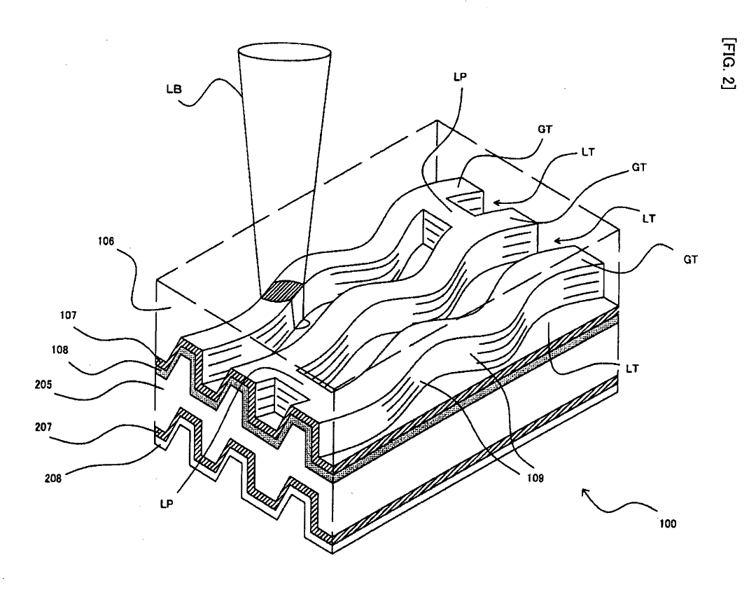

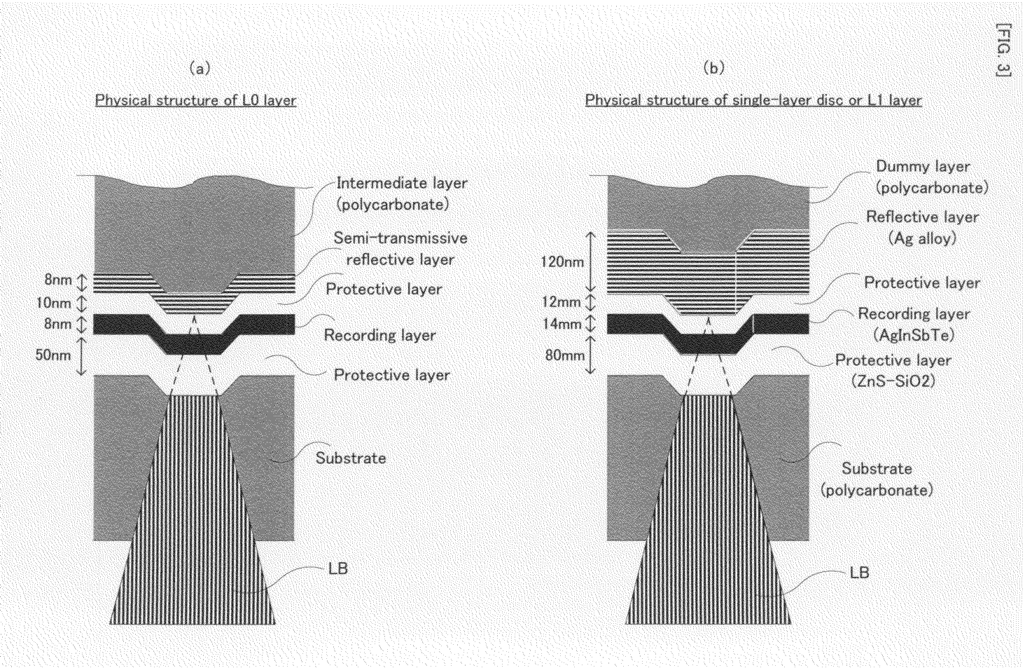

Next, with reference to FIG. 2 and FIG. 3, an explanation will be given on the outline of the physical structure of the dual-layer type optical disc in the first embodiment of the information recording medium of the present invention. FIG. 2 is an enlarged perspective view showing a partially enlarged recording surface, in the optical disc in the first embodiment of the information recording medium of the present invention. FIG. 3 are enlarged cross sectional views showing partially enlarged cut surfaces of recording layers, in the optical disc in the first embodiment of the information recording medium of the present invention. Incidentally, for convenience of explanation, FIG. 2 corresponds to the case that the laser light is irradiated from the upper side to the lower side, and FIG. 3 correspond to the case that the laser light is irradiated from the lower side to the upper side.

As shown in FIG. 2, in the optical disc 100 in the embodiment, a first recording layer (L0 layer) 107 of a phase change recording type, which constitutes a recording surface (or signal surface), is laminated on the lower side of the disc-shaped transparent substrate 106, and a semi-transmissive reflective film (or semi-transmissive reflective layer) 108 is laminated on the lower side thereof. On the lower side of the semi-transmissive reflective film 108, a second recording layer (or L1 layer) 207 is formed, and a reflective film (or reflective layer) 208 is formed on the lower side thereof. The second recording layer 207 and the reflective film 208 may be laminated, i.e. film-formed, on the transparent substrate 106 on which the first recording layer 107 and the semi-transmissive reflective film 108 or the like are formed. Alternatively, the second recording layer 207 and the reflective film 208 may be laminated, i.e. film-formed, on different substrates and then bonded on the transparent substrate 106. Incidentally, between the semi-transmissive reflective film 108 and the second recording layer 207, there is provided a transparent intermediate layer 205 formed of a transparent adhesive or the like, depending on the manufacturing method, as occasion demands.

More specifically, as shown in FIG. 3(a), the L0 layer corresponding to the aforementioned first recording layer may be formed mostly of “Ag”, “In”, “Sb”, and “Te” or the like, and the layer thickness or the film thickness may be set relatively small, e.g. 8 (nm), compared to that of the L1 layer or the like described later. A protective layer, formed on a side (the lower side in FIG. 3) where the L0 layer is irradiated with the laser light LB, may be formed mainly of “ZnS” and “SiO2” or the like, and the film thickness may be set to relatively small, e.g. 50 (nm), compared to that of the L1 layer or the like described later. On the other hand, a protective layer, formed on a side (the upper side in FIG. 3) opposite to the side where the L0 layer is irradiated with the laser light LB, may be also formed mainly of “ZnS” and “SiO2” or the like, and the film thickness may be set to relatively small, e.g. 10 (nm), compared to that of the L1 layer or the like described later. A semi-transmissive reflective layer, formed on the upper side of the protective layer, may be formed mostly of “Ag alloy” or the like, and the film thickness may be set relatively considerably small, e.g. 8 (nm), compared to that of the L1 layer or the like described later.

On the other hand, as shown in FIG. 3(b), the L1 layer corresponding to the aforementioned second recording layer, or a single recording layer of a single-layer type optical disc, may be formed mostly of “Ag”, “In”, “Sb”, and “Te” or the like, and the film thickness may be set relatively large, e.g. 14 (nm), compared to that of the aforementioned L0 layer. A protective layer, formed on a side (the lower side in FIG. 3) where the L1 layer or the single recording layer is irradiated with the laser light LB, may be formed mainly of “ZnS” and “SiO2” or the like, and the film thickness may be set to e.g. 80 (nm). On the other hand, a protective layer, formed on a side (the upper side in FIG. 3) opposite to the side where the L1 layer or the single recording layer is irradiated with the laser light LB, may be also formed mainly of “ZnS” and “SiO2” or the like, and the film thickness may be set to e.g. 12 (nm). A semi-transmissive reflective layer, formed on the upper side of the protective layer, may be formed mostly of “Ag alloy” or the like, and the film thickness may be set relatively considerably large, e.g. 120 (nm), compared to that of the aforementioned L0 layer

Back to the explanation in FIG. 2 again, on the recording surface, which is formed of the surfaces of the first recording layer 107 or the second recording layer 207, there are alternately formed groove tracks GT and land tracks LT. The groove track GT is oscillated with a constant amplitude and at a constant spatial frequency. That is, the groove track is wobbled, and the cycle of the wobble 109 is set to a predetermined value. On the land track LT, there is formed an address pit which is referred to as a land pre-pit LPP and which indicates pre-format address information. By virtue of the two addressing (i.e. the wobble 109 and the land pre-pit LP), it is possible to obtain information necessary for (i) disc rotation control during the recording, (ii) generation of a recording clock, or (iii) data recording, such as a recording address. Incidentally, it is also possible to prerecord the pre-format address by modulating the wobble 109 of the groove track GT in a predetermined modulation method, such as frequency modulation and phase modulation.

Moreover, in recording or reproducing the record data in the first recording layer 107, the groove track GT is irradiated with the laser light LB, through the transparent substrate 106. For example, in the recording, the laser light LB is irradiated with a laser power for recording, to thereby perform the recording (or writing) by a phase change with respect to the first recording layer 107, in accordance with the record data. On the other hand, in the reproduction, the laser light LB is irradiated with a laser power for reproduction, which is smaller (weaker) than the laser power for recording, to thereby read the record data recorded in the first recording layer 107. Similarly, in recording and reproducing the record data in the second recording layer 207, the laser light LB is irradiated through the transparent substrate 106, the first recording layer 107, and the semi-transmissive reflective film 108, to thereby perform the recording of a phase change recording type, or reproduction, substantially in the same manner as in the first recording layer 107. In addition, upon the recording and reproduction of the dual-layer type optical disc 100, the recording and reproduction in the first recording layer 107 or in the second recording layer 207 are performed, depending on the focus position of the laser light LB, i.e. which recording layer is focused.

(1-3) Logical Structure

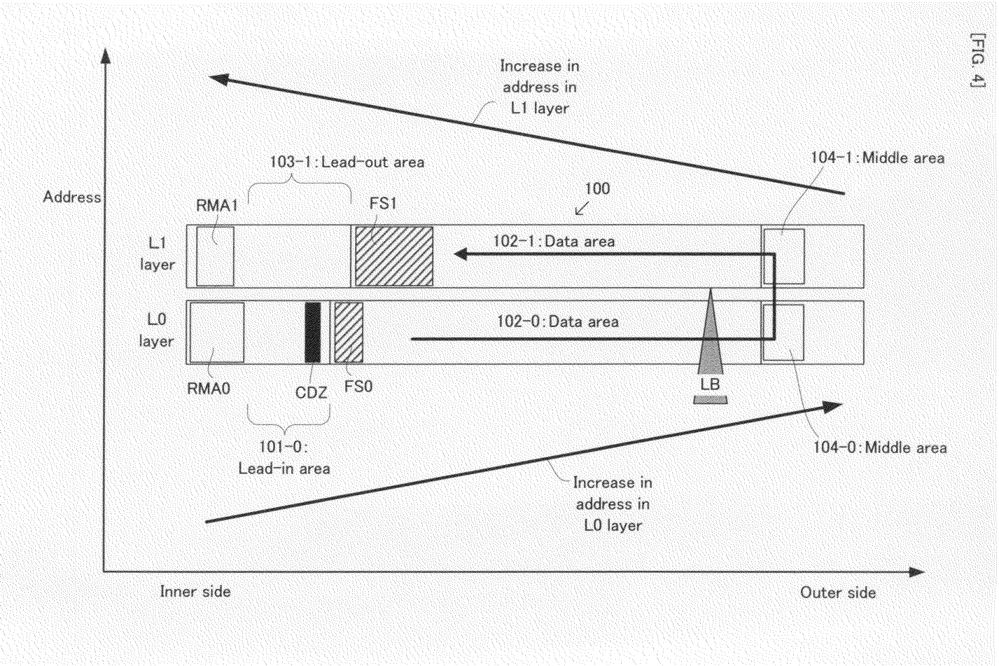

Next, with reference to FIG. 4, an explanation will be given on the logical structure of the dual-layer optical disc in the embodiment of the information recording medium of the present invention. FIG. 4 is a graph conceptually showing the data structure of the dual-layer optical disc in the embodiment of the information recording medium of the present invention, an address, such as a physical sector number which constitutes an ECC block, in the recording area of the optical disc, and a recording or reproducing method by an opposite method in the optical disc. Incidentally, the vertical axis in FIG. 4 indicates the address, such as a sector number, expressed in hexadecimal numbers, and the horizontal axis indicates a relative position in the radial direction of the optical disc. Incidentally, the optical disc in the embodiment mainly employs an opposite method in which the track path in the L0 layer and the track path in the L1 layer have opposite travel directions, as one specific example of the recording or reproducing method.

As shown in FIG. 4, the dual-layer optical disc 100 in the embodiment of the information recording medium of the present invention is provided with two recording layers, i.e. the L0 layer and the L1 layer, laminated on a not-illustrated transparent substrate. Specifically, the L0 layer is provided with: (i) a recording management area RMA0, associated with the management area of the present invention; (ii) a lead-in area 101-0 including a control data zone CDZ; (iii) a data area 102-0 including a recording area in which a file system FS0, associated with the control information of the present invention, is recorded; and (iv) a middle area 104-0, from the inner to the outer circumferential side.

In particular, the file system FS0 (and FS1) logically or physically manages a position in which the record data is recorded, in the recording or reproduction of the record data. Incidentally, the file system will be detailed later. Moreover, the recording capacity of the recording area in which the file system FS0 (and FS1) is recorded may be fixed or variable.

Specifically, in the RMA0 (and RMA1 described later), RMD can be recorded, wherein the RMD constitutes one example of the management information including the identification information of the present invention, described later. Specifically, in the RMA0 (and RMA1 described later), the RMD can be recorded about 700 times. Moreover, in the control data zone CDZ, various information, such as the number of recording layers, the direction of the recording track, and a track pitch, is prerecorded by using laser light or the like. Moreover, in the data area 102-0, the record data can be recorded. Moreover, the middle area 104-0 has a basic function of preventing a recording or reproduction position in the L0 layer and the L1 layer from being away to an unrecorded area or off the substrate; however, it also has a function, as a so-called “jump buffer area”, of preventing the recording or reproduction position from being away to the unrecorded area or off the substrate in layer jump.

On the other hand, the L1 layer is provided with: a middle area 104-1; a data area 102-1 including a recording area in which the file system FS1, associated with the control information of the present invention, is recorded; a lead-out area 103-1; and a recording management area RMA 1, from the outer to the inner circumferential side. More specifically, the RMA 0 (RMA 1) and a not-illustrated power calibration area may be collectively referred to as an “Information Area”. Moreover, the aforementioned lead-in area 101-0 (lead-out area 103-1), data area 102-0 (102-1), and middle area 104-0 (104-1) may be collectively referred to as a “R-Information Area”.

The dual-layer type optical disc 100 is constructed in the above manner, so that in the recording or reproduction of the optical disc 100, the laser light LB is irradiated by an optical pickup or the like of an information recording/reproducing apparatus, which is one specific example of the information recording apparatus of the present invention described later, from the not-illustrated substrate side, i.e., from the lower side to the upper side in FIG. 4, to thereby control the focal distance thereof or the like, and also control the travel distance and direction in the radial direction of the optical disc 100. By this, the data is recorded into each recording layer, or the recorded data is reproduced.

As the recording or reproduction procedure for the dual-layer type optical disc in the embodiment of the information recording medium of the present invention, the opposite method is adopted. The opposite method herein is, more specifically, such a method that, as the recording or reproduction procedure for the two-layer type optical disc, the optical pickup of the information recording/reproducing apparatus described later is displaced from the inner to the outer circumferential side, i.e. in a direction of a right-pointing arrow in FIG. 4, in the L0 layer, whereas the optical pickup is displaced from the outer to the inner circumferential side, i.e. in a direction of a left-pointing arrow in FIG. 4, in the L1 layer, to thereby perform the recording or reproduction on the dual-layer type optical disc. In the opposite method, if the recording or reproduction is ended in the L0 layer, the optical pickup, located on the outermost circumference of the optical disc, does not have to be displaced again to the innermost circumference when the recording or reproduction is started in the L1 layer, and it is only necessary to change the focal distance from the L0 layer to the L1 layer. Thus, there is an advantage that a changing time from the L0 layer to the L1 layer is shorter than that in the parallel method. This is why the opposite method is employed for the recording of a large-volume of content information.

Specifically, as shown in a graph part of FIG. 4, firstly, in the L0 layer, as the optical pickup is displaced in the lead-in area 101-0, the data area 102-0, and the middle area 104-0, from the inner to the outer circumferential side, the address, such as the sector number, in the recording areas of the optical disc 100 increases. On the other hand, in the L1 layer, as the optical pickup is displaced in the middle area 104-1, the data area 102-1, and the lead-out area 103-1, from the outer to the inner circumferential side, the address, such as the sector number, in the recording areas of the optical disc 100 increases. Incidentally, all the addresses, such as the sector numbers, in the L0 layer and the L1 layer may have a 15's complement number relationship in the hexadecimal numbers.

With respect to the address, such as the physical sector number, explained above, a LSN (Logical Sector Number) or a LBA (Logical Block Address) may be allocated in a one-to-one manner. Specifically, “000000” LSN may correspond to the sector number “030000h”, and “17FFFF” LSN may correspond to a sector number “1AFFFFh”.

As a result, for example, a host computer can perform the recording and reproduction operations, in accordance with the logical block address managed by the file system, associated with the control information of the present invention, without regard to the physical sector number.

(1-4) One Specific Example of File System

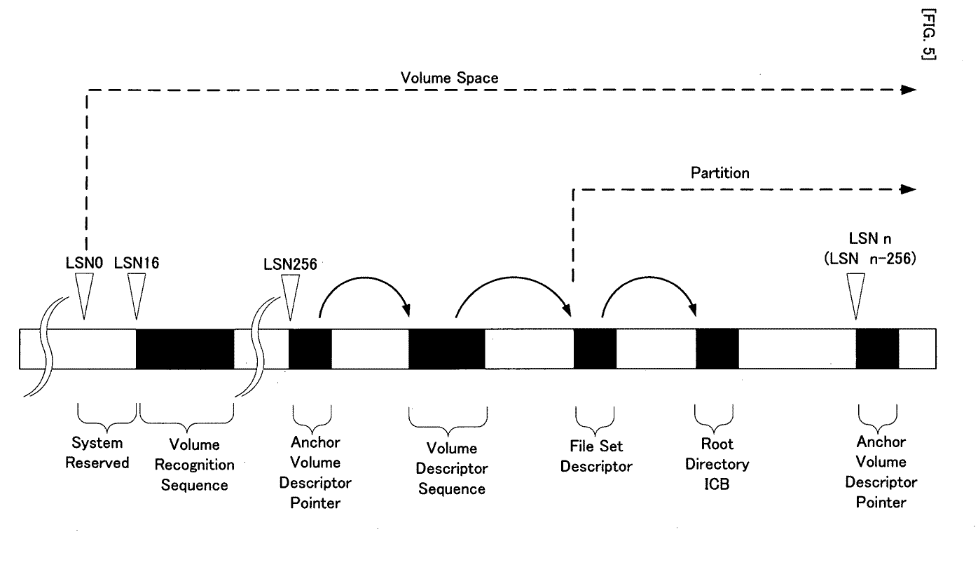

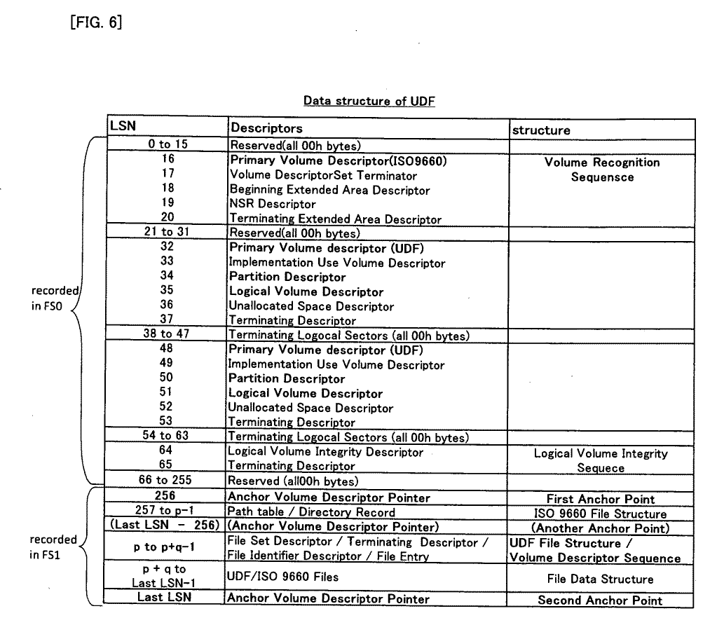

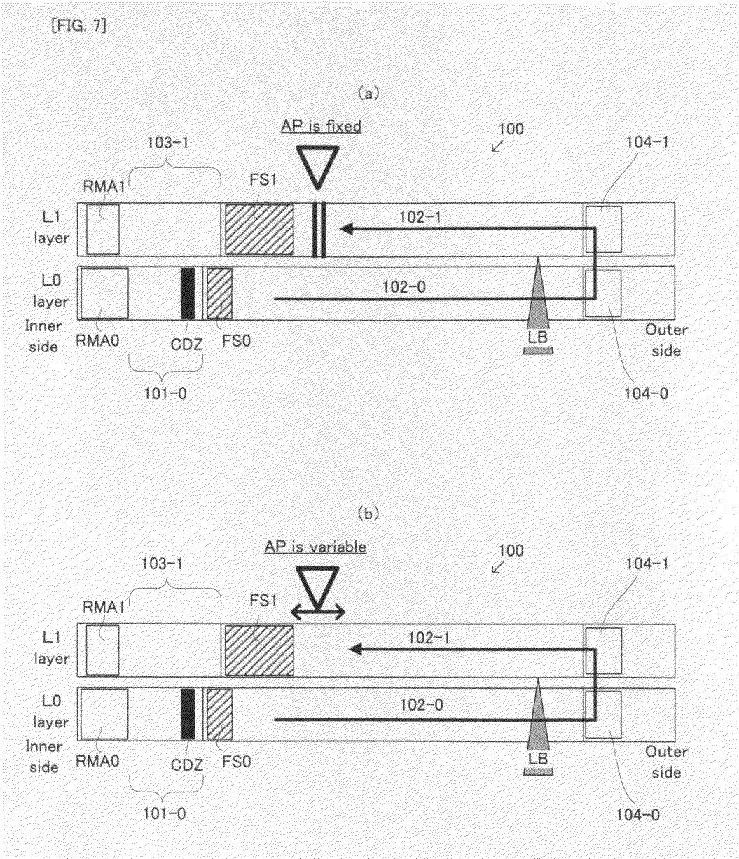

Next, with reference to FIG. 5 to FIG. 7, an explanation will be given on a UDF (Universal Disk Format), which is one specific example of the file system, associated with the control information of the present invention. FIG. 5 is a schematic diagram conceptually showing the basic structure of the UDF, which is one specific example of the file system associated with the control information of the present invention. FIG. 6 is a schematic table conceptually showing the data structure of the UDF, which is one specific example of the file system associated with the control information of the present invention. FIG. 7 are schematic diagrams (FIG. 7(a) and FIG. 7(b)) conceptually showing two types of anchor points, which constitute the UDF, which is one specific example of the file system associated with the control information of the present invention.

As shown in FIG. 5, the UDF, which is one specific example of the file system associated with the control information of the present invention, is provided with the following six types of information, and it is recorded in e.g. the data area. That is, the six types of information is: (i) VRS (Volume Recognition Sequence), (ii) one kind of AVDP (Anchor Volume Descriptor Pointer), (iii) VDS (Volume Descriptor Sequence), (iv) FSD (File Set Descriptor), (v) RDICB (Rot Directory ICB), and (vi) another kind of AVDP (Anchor Volume Descriptor Pointer).

Specifically, (i) the VRS (Volume Recognition Sequence) includes information about whether or not the UDF complies with e.g. ECMA (European Computer Manufactures Association) 167, or information about ISO (International Organization for Standardization) 9660. Specifically, the VRS, as shown in FIG. 5 and FIG. 6, may be recorded, for example, from 16 (LSN: Logical Sector Number) to 65 (LSN) of the volume space of the data area.

(ii) The one kind of AVDP and another kind of AVDP (Anchor Volume Descriptor Pointer) include pointer information, which indicates the position of an end edge in which the record data is recorded. Specifically, the AVDP, as shown in FIG. 5 and FIG. 6, may be recorded, for example, in 256 (LSN) and n (LSN), out of 256 (LSN), n (LSN) which indicates the last LSN, and n−256 (LSN) in the volume space of the data area.

(iii) The VDS (Volume Descriptor Sequence) may include information, such as (iii-1) PVD (Primary Volume Descriptor), (iii-2) LVD (Logical Volume Descriptor) having the pointer information for the aforementioned FSD, and (iii-3) PD (Partition Descriptor), shown in FIG. 6, as a UDF file structure.

(iv) The FSD (File Set Descriptor) may include the pointer information for the aforementioned RDICB.

(v) The RDICB (Root Directory ICB) may include a Root Directory File itself, or the pointer information for the Root Directory File.

In particular, in the embodiment, as shown in FIG. 6, the information, such as AVDP and VDS recorded, for example, from 256 (LSN) to the last n (LSN), whose rewriting frequency is relatively high, is recorded into the L1 layer as the file system FS1. In addition, the information, such as VRS recorded, for example, from 0 (LSN) to 255 (LSN), whose rewriting frequency is relatively low, is recorded into the L0 layer as the file system FS0.

More specifically, as shown in FIG. 7(a), if the position of an anchor point AP, which is an end edge in which the record data is recorded, is fixed, the AVDP recorded in 256 (LSN) is regarded as the information whose rewriting frequency is relatively low. Thus, the information, such as VDS, recorded from 257 (LSN) to the last n (LSN), excluding 256 (LSN), may be recorded into the L1 layer, as the file system FS1.

On the other hand, as shown in FIG. 7(b), if the position of the anchor point AP, which is the end edge in which the record data is recorded, is not fixed but is variable, the AVDP is regarded as the information whose rewriting frequency is relatively high. Thus, the AVDP may be recorded into n−256 (LSN) and n (LSN), and the information, such as AVDP or VDS, recorded from 257 (LSN) to the last n (LSN), including n−256 (LSN) and n (LSN), may be recorded into the L1 layer, as the file system FS1.

As a result, a quantitatively and qualitatively preferable correlation can be maintained between (i) the number of rewriting times determined on the basis of the logical attribute and characteristics, as the target of the software program and the application or as the control information, such as a file system, in the record data and (ii) the number of rewriting times determined on the basis of the physical properties in the first or second recording layer in which the record data is supposed to be recorded. Therefore, it is possible to record the record data including the control information, such as a file system, into the more preferable recording layer, more efficiently. Consequently, for example, the number of times of actually recording the record data including the control information into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

### (2) Embodiment of Information Recording Apparatus

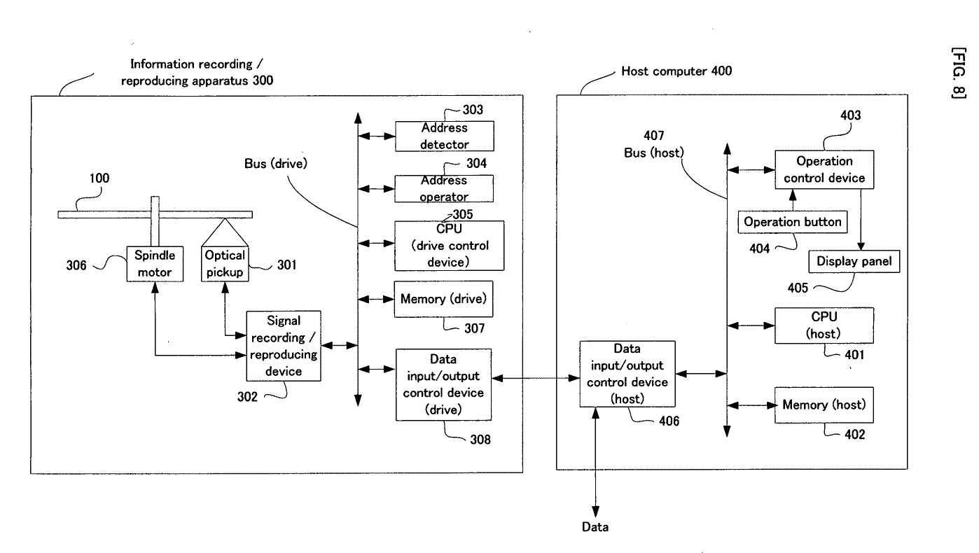

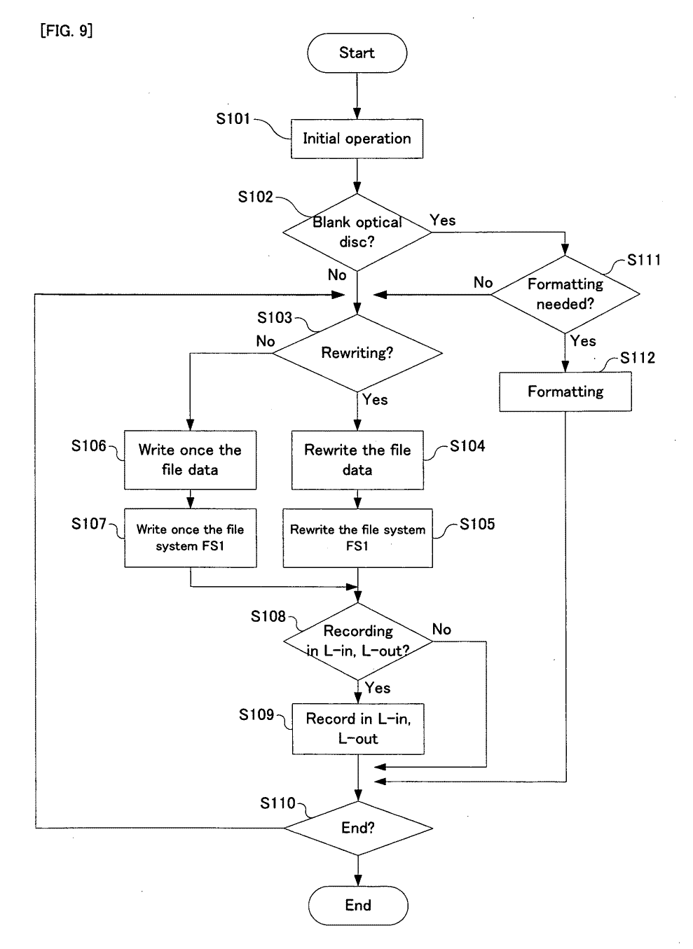

Next, with reference to FIG. 8 and FIG. 9, the structure and the operation of am information recording apparatus in an embodiment of the present invention will be explained in detail. In particular, the embodiment is an example in which the information recording apparatus of the present invention is applied to an information recording/reproducing apparatus for an optical disc.

(2-1) Basic Structure

Firstly, with reference to FIG. 8, an explanation will be given for the basic structures of an information recording/reproducing apparatus 300 in the embodiment of the information recording apparatus of the present invention and a host computer 400. FIG. 8 is a block diagram showing the basic structures of the information recording/reproducing apparatus in the embodiment of the information recording apparatus of the present invention and the host computer. Incidentally, the information recording/reproducing apparatus 300 has a function of recording record data onto the optical disc 100 and a function of reproducing the record data recorded on the optical disc 100.

With reference to FIG. 8, the inner structure of the information recording/reproducing apparatus 300 will be explained. The information recording/reproducing apparatus 300 is an apparatus for recording information onto the optical disc 100 and reading the information recorded on the optical disc 100, under the control of a CPU (Central Processing Unit) 305 for drive.

The information recording/reproducing apparatus 300 is provided with: the optical disc 100; an optical pickup 301; a signal recording/reproducing device 302; an address detector 303; an address operator 304; the CPU (drive control device) 305; a spindle motor 306; a memory 307; a data input/output control device 308; and a bus 309.

Moreover, the host computer 400 is provided with: a CPU (host control device) 401; a memory 402; an operation control device 403; an operation button 404; a display panel 405; a data input/output control device 406; and a bus 407.

In particular, the information recording/reproducing apparatus 300 may be constructed to be capable of communicating with an external network, by housing the host computer 400 provided with a communication device, such as a modem, for example, in the same package. Alternatively, the information recording/reproducing apparatus 300 may be constructed to be capable of communicating with an external network, by that the CPU (host control device) 401 of the host computer 400 provided with a communication device, such as an i-link, directly controls the information recording/reproducing apparatus 300 via the data input/output control device 308 and the bus 309.

The optical pickup 301 performs the recording/reproduction with respect to the optical disc 100 and is provided with: a semiconductor laser apparatus; and a lens. More specifically, the optical pickup 301 irradiates the optical disc 100 with a light beam, such as a laser beam, as reading light with a first power upon reproduction, and as writing light with a second power upon recording, with it modulated.

The signal recording/reproducing device 302 performs the recording/reproduction with respect to the optical disc 100 by controlling the optical pickup 301 and the spindle motor 306. More specifically, the signal recording/reproducing device 302 is provided with a laser diode (LD) driver, a head amplifier, and the like. The LD driver drives the not-illustrated semiconductor laser built in the optical pickup 352. The head amplifier amplifies the output signal of the optical pickup 352, i.e., the reflected light of the light beam, and outputs the amplified signal. More specifically, the signal recording/reproducing device 302 drives the not-illustrated semiconductor laser built in the optical pickup 352 so as to determine an optimum laser power by a process of recording and reproducing an OPC pattern, together with a not-illustrated timing generator, under the control of the CPU 305, at the time of OPC (Optimum Power Control) process. In particular, the signal recording/reproducing device 302 constitutes one example of the “recording device”, the “reproducing device”, and the “recording/reproducing device” of the present invention, with the optical pickup 301. Moreover, the signal recording/reproducing device 302 may be capable of obtaining the file system FS0 recorded in the L0 layer, in addition to the file system FS1 recorded in the L1 layer. Thus, the signal recording/reproducing device 302 may constitute one example of the “obtaining device” of the present invention.

The address detector 303 detects the address (address information) on the optical disc 100, from a reproduction signal including a pre-format address signal or the like, outputted by the signal recording/reproducing device 302.

The OPC operator 304 may perform an operation or calculation, such as adding or subtracting an address offset value, on the detected address.

The CPU (drive control device) 305 controls the entire information recording/reproducing apparatus 300 by giving instructions to various control devices through the bus 309. In particular, the CPU 305 can control the recording or reproduction of the record data by the signal recording/reproducing device 302, on the basis of the file systems FS0 and FS1, obtained by the signal recording/reproducing device 302. Moreover, software or firmware for operating the CPU 305 is stored in the memory 307. In particular, the CPU 305 is one example of the “controlling device” of the present invention.

The spindle motor 306 is intended to rotate and stop the optical disc 100, and operates in accessing the optical disc 100. More specifically, the spindle motor 306 is constructed to rotate and stop the optical disc 100 at a predetermined speed under spindle servo by a not-illustrated servo unit or the like.

The memory 307 is used in the general data processing and the OPC processing on the information recording/reproducing apparatus 300, including a buffer area for the record/reproduction data, an area used as an intermediate buffer when data is converted into the data that can be used on the signal recording/reproducing device 302, and the like. Moreover, the memory 307 is provided with: a ROM area into which a program for performing an operation as such a recording device, i.e. firmware, is stored; a buffer for temporarily storing the record/reproduction data; a Random Access Memory (RAM) area into which a parameter required for the operation of the firmware program or the like is stored; and the like.

The data input/output control device 308 controls the data input/output from the exterior with respect to the information recording/reproducing apparatus 300, and performs storage and export with respect to the data buffer on the memory 307. A drive control command, which is issued from the external host computer 400 (hereinafter referred to as a “host”, as occasion demands) connected to the information recording/reproducing apparatus 300 via an interface, such as a SCSI (Small Computer System Interface) and an ATAPI (AT Attachment Packet Interface), is transmitted to the CPU 305 through the data input/output control device 308. Moreover, the record/reproduction data is also exchanged with the host computer 400 through the data input/output control device 308 in the same manner.

The CPU (host control device) 401, the memory 402, the data input/output control device 406, and the bus 407 of the host computer 400 are substantially the same as the corresponding constituent elements in the information recording/reproducing apparatus 300.

The operation control device 403 performs reception of an operation instruction and display with respect to the host computer 400. The operation control device 403 sends an instruction of recording or reproduction by using the operation bottom 404, for example, to the CPU 401. The CPU 401 may send a control command to the information recording/reproducing apparatus 300 through the data input/output control device 406, on the basis of the instruction information from the operation control device 403, to thereby control the entire information recording/reproducing apparatus 300. In the same manner, the CP.U 401 can send a command of requiring the information recording/reproducing apparatus 300 to send the operation condition to the host, to the information recording/reproducing apparatus 300. By this, it is possible to recognize the operation condition of the information recording/reproducing apparatus 300, such as during recording and during reproduction. Thus, the CPU 401 can output the operation condition of the information recording/reproducing apparatus 300, to the display panel 405, such as a fluorescent tube and a LCD, through the operation control device 403.

One specific example used by combining the information recording/reproducing apparatus 300 and the host computer 400, as explained above, is household equipment, such as recorder equipment for recording and/or reproducing video images. The recorder equipment records a video signal from a broadcast reception tuner and an external connection terminal, onto a disc, and outputs the video signal reproduced from the disc, to external display equipment, such as a television. The operation as the recorder equipment is performed by executing a program stored in the memory 402, on the CPU 401. Moreover, in another specific example, the information recording/reproducing apparatus 300 is a disc drive (hereinafter referred to as a drive, as occasion demands), and the host computer 400 is a personal computer or a workstation. The host computer 400, such as the personal computer, and the drive are connected to each other through the data input/output control device 308 (406), such as the SCSI and the ATAPI. An application, such as writing software, which is installed in the host computer, controls the disc drive.

(2-2) Operation Principle

Next, with reference to FIG. 8 described above, as occasion demands, in addition to FIG. 9, an explanation will be given on one specific example of the operation principle of the information recording/reproducing apparatus in the embodiment of the information recording apparatus of the present invention. Incidentally, as the one specific example of the operation principle in the embodiment, an explanation will be given on a recording process when the position of the anchor point is fixed, wherein the anchor point is the end edge in which the record data based on a UDF version 1.02 is recorded. FIG. 9 is a flowchart showing the recording process including (i) rewriting or additional recording of file data, such as user data, and (ii) rewriting or additional recording of the file system, such as a UDF, performed by the information recording/reproducing apparatus in the embodiment of the information recording apparatus of the present invention.

As shown in FIG. 9, firstly, when the optical disc is inserted, various management information is read from e.g. the CDZ and the RMA, as an initial operation, under the control of the CPU (drive control device) 305 (step S101).

Then, under the control of the CPU 305, it is judged whether or not the optical disc is a blank optical disc in which the file data, such as user data, is unrecorded (step S102). If the optical disc is not the blank optical disc in the unrecorded state (the step S102: No), it is judged whether or not the rewriting of the file data is performed under the control of the CPU 305 (step S103). Here, if the rewriting of the file data is performed (the step S103: Yes), the file data is rewritten, under the control of the CPU 305 (step S104). Then, in respond to the rewriting of the file data, rewriting is performed on the file system FS1, such as AVDP and VDS recorded, for example, from 256 (LSN) to the last n (LSN), whose rewriting frequency is relatively high and which is based on the UDF shown in the aforementioned FIG. 6 (step S105).

On the other hand, as a result of the judgment in the step S103, if the rewriting of the file data is not performed but the additional recording of the file data is performed (the step S103: No), the file data is additionally recorded or written once, under the control of the CPU 305 (step S106). Then, in respond to the additional recording of the file data, additional recording is performed on the file system FS1, such as AVDP and VDS recorded, for example, from 256 (LSN) to the last n (LSN), whose rewriting frequency is relatively high and which is based on the UDF shown in the aforementioned FIG. 6 (step S107).

Then, it is judged whether or not the recording is performed in the lead-in area or the lead-out area, under the control of the CPU 305 (step S108). Here, if it is judged that the recording is performed in the lead-in area or the lead-out area (the step S108: Yes), the recording is performed in the lead-in area or the lead-out area (step S109). On the other hand, as a result of the judgment in the step S108, if it is judged that the recording is not performed in the lead-in area or the lead-out area (the step S108: No), the aforementioned step S109 is omitted.

It is judged whether or not the recording process is ended, under the control of the CPU 305 (step S110). Here if the recording process is ended (the step S110: Yes), the series of recording process is ended. On the other hand, if the recording process is not ended (the step S110: No), it may be judged whether or not the rewriting of the file data is performed, under the control of the CPU 305, as described above (the step S103).

On the other hand, as a result of the judgment in the step S102, if the optical disc is the blank optical disc in the unrecorded state (the step S102: Yes), it is judged whether or not formatting, such as initializing, is performed on the optical disc, under the control of the CPU 305 (step S111). If it is judged that the formatting is performed (the step S111: Yes), the formatting, such as initializing, is performed under the control of the CPU 305 (step S112). On the other hand, if the formatting is not performed (the step S111: No), it may be judged whether or not the rewriting of the file data is performed, under the control of the CPU 305, as described above (the step S103).

### (3) Second Embodiment of Information Recording Medium

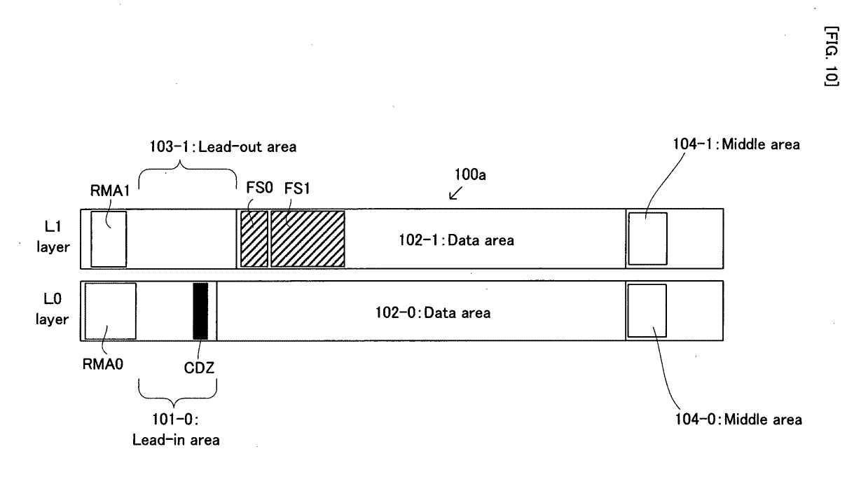

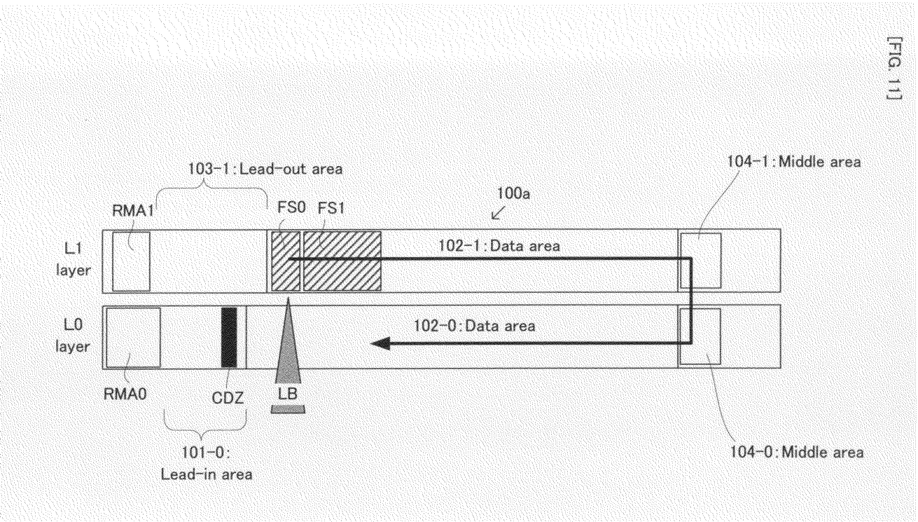

Next, with reference to FIG. 10 and FIG. 11, an information recording medium in a second embodiment of the present invention will be discussed. FIG. 10 is a schematic diagram conceptually showing the data structure of a dual-layer optical disc in the second embodiment of the information recording medium of the present invention. FIG. 11 is a schematic diagram conceptually showing the data structure of the dual-layer optical disc in the second embodiment of the information recording medium of the present invention, and a recording or reproducing method by the opposite method in the optical disc. Incidentally, the structure of the optical disc in the second embodiment, and the recording or reproducing method are substantially the same as those in the first embodiment. Thus, the same elements carry the same numerical references, and the explanation thereof will be omitted.

In an optical disc 100a in the second embodiment, as shown in FIG. 10, a file system FS1, such as AVDP and VDS recorded, for example, from 256 (LSN) to the last n (LSN), whose rewriting frequency is relatively high, as shown in the aforementioned FIG. 6, is recorded in the L1 layer. In addition, a file system FS0, such as VRS recorded, for example, from 0 (LSN) to 255 (LSN), whose rewriting frequency is relatively low, is also recorded in the L1 layer similarly.

In addition, with regard to the recording order or reproduction order by the opposite method for the optical disc 100a in the second embodiment, as shown in FIG. 11, the reproduction may be firstly performed from the inner circumferential side to the outer circumferential side of the L1 layer, which is located on the rear side, viewed from the irradiation side of the laser light, and the reproduction may be secondly performed from the outer circumferential side to the inner circumferential side of the L0 layer, which is located on the front side, viewed from the irradiation side of the laser light.

As a result, for example, by a series of obtaining process following the initial operation of the recording or reproducing process on the information recording/reproducing apparatus, it is possible to obtain the file system FS0 whose rewriting frequency is relatively low, in addition to the file system FS1 whose rewriting frequency is relatively high, quickly and accurately.

### (4) Third Embodiment of Information Recording Medium

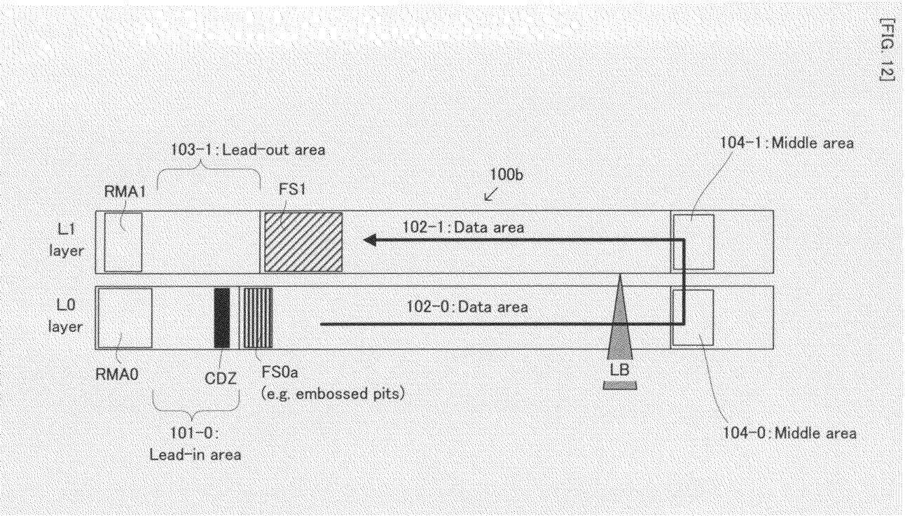

Next, with reference to FIG. 12, an information recording medium in a third embodiment of the present invention will be discussed. FIG. 12 is a schematic diagram conceptually showing the data structure of a dual-layer optical disc in the third embodiment of the information recording medium of the present invention. Incidentally, the structure of the optical disc in the third embodiment, and the recording or reproducing method are substantially the same as those in the first embodiment. Thus, the same elements carry the same numerical references, and the explanation thereof will be omitted.

In an optical disc 100b in the third embodiment, as shown in FIG. 12, a file system FS0a, such as VRS recorded, for example, from 0 (LSN) to 255 (LSN), whose rewriting frequency is relatively low or whose rewriting is hardly or not performed at all, as shown in the aforementioned FIG. 6, may be recorded in advance in the L0 layer, for example, by the formation of embossed pits without wobbling (or oscillation).

As a result, it is possible to simplify the recording of the file system FS0a, whose rewriting frequency is relatively low or whose rewriting is hardly or not performed at all. In addition, for example, this can prevent incorrect overwriting, so that it is possible to protect the file system FS0a, whose rewriting frequency is relatively low or whose rewriting is hardly or not performed at all.

### (5) Fourth Embodiment of Information Recording Medium

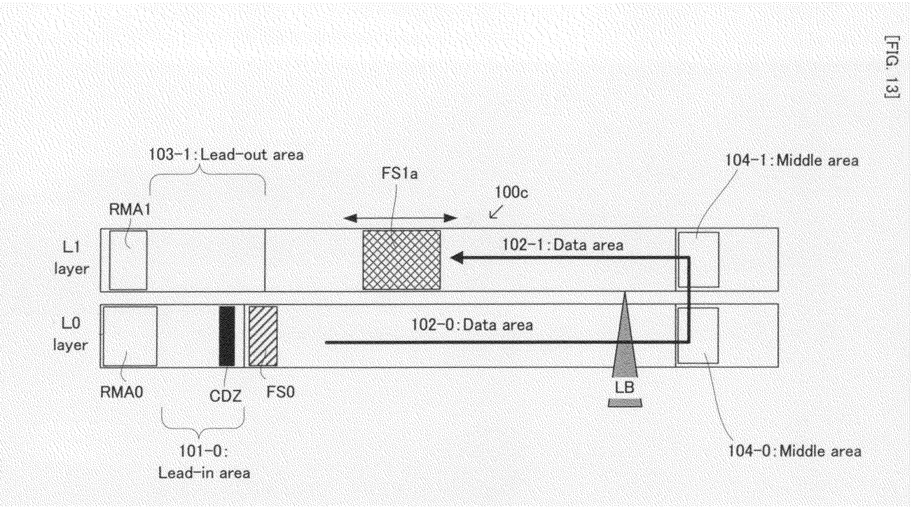

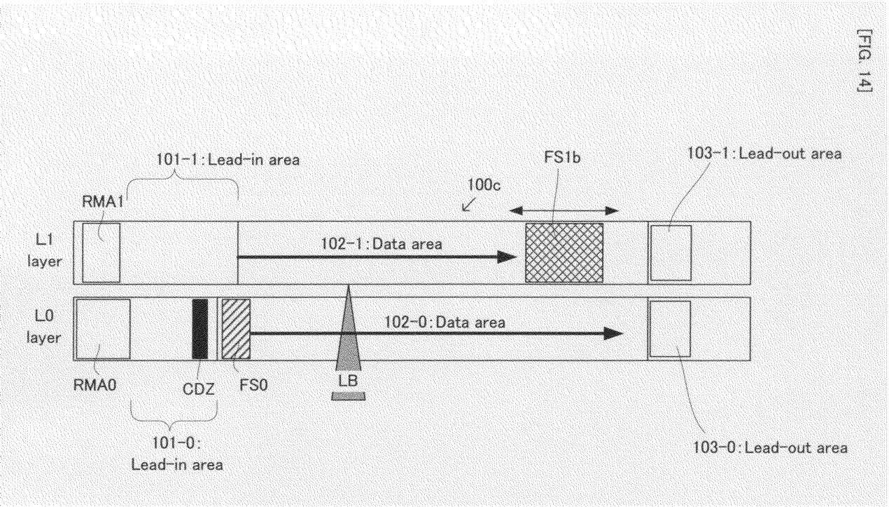

Next, with reference to FIG. 13 and FIG. 14, an information recording medium in a fourth embodiment of the present invention will be discussed. FIG. 13 is a schematic diagram conceptually showing the data structure of a dual-layer optical disc in the fourth embodiment of the information recording medium of the present invention, and a recording or reproducing method by the opposite method in the optical disc. FIG. 14 is a schematic diagram conceptually showing the data structure of the dual-layer optical disc in the fourth embodiment of the information recording medium of the present invention, and a recording or reproducing method by a parallel method in the optical disc. Incidentally, the structure of the optical disc in the fourth embodiment, and the recording or reproducing method are substantially the same as those in the first embodiment. Thus, the same elements carry the same numerical references, and the explanation thereof will be omitted.

In an optical disc 100c in the fourth embodiment, as shown in FIG. 13, under the opposite method, a file system FS1a, such as AVDP and VDS recorded, for example, from 256 (LSN) to the last n (LSN), whose rewriting frequency is relatively high, as shown in the aforementioned FIG. 6, may be recorded adjacent to the end edge in which the record data is recorded in the L1 layer and on the inner circumferential side.

Alternatively, in the optical disc 100c in the fourth embodiment, as shown in FIG. 14, under the parallel method, a file system FS1b, whose rewriting frequency is relatively high, may be recorded adjacent to the end edge in which the record data is recorded in the L1 layer and on the outer circumferential side.

As a result, for example, by a series of process following the recording or reproducing process on the information recording/reproducing apparatus, it is possible to perform the rewriting or additional recording of the file system FS1 whose rewriting frequency is relatively high, quickly and accurately, in respond to a change in the data amount of the file system FS1a or FS1b.

### (6) Fifth Embodiment of Information Recording Medium

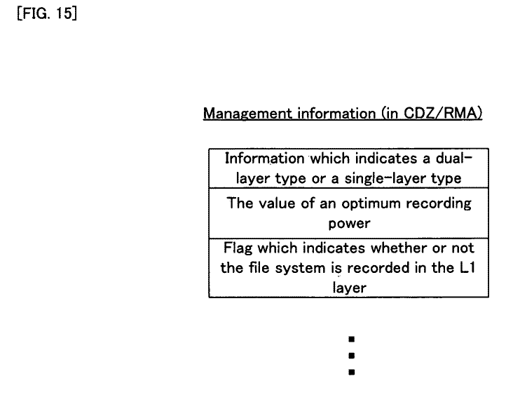

Next, with reference to FIG. 15, an explanation will be given on one specific example of the management information in an information recording medium in a fifth embodiment of the present invention. FIG. 15 is a table showing the management information including the identification information (flag) or the like, which indicates whether or not the file system is recorded in the L1 layer, in the fifth embodiment of the information recording medium of the present invention.

As shown in FIG. 15, for example, the management information recorded in the CDZ or the RMD may include (i) information which indicates that the optical disc is of a dual-layer type or a single-layer type, (ii) the value of an optimum recording power for the recording layer of the optical disc, and (iii) the identification information (e.g., flag information) which indicates whether or not the file system is recorded in the L1 layer.

In addition, a field may be held to record: (iv) identification number information of the information recording/reproducing apparatus which performs the recording operation on the optical disc, i.e. drive ID information (drive identification information); and (v) disc state information, which indicates an unrecorded state, a recording method, (such as an incremental recording method,) and a state in which a finalizing process, which cannot be additionally recorded or written once, has been performed.

As a result, for example, the information recording/reproducing apparatus can simply judge whether or not the file system is recorded in the L1 layer on the optical disc which is a recording or reproduction target, to thereby perform the recording or reproduction on the information recording medium, quickly and accurately.

### (7) Sixth Embodiment of Information Recording Medium

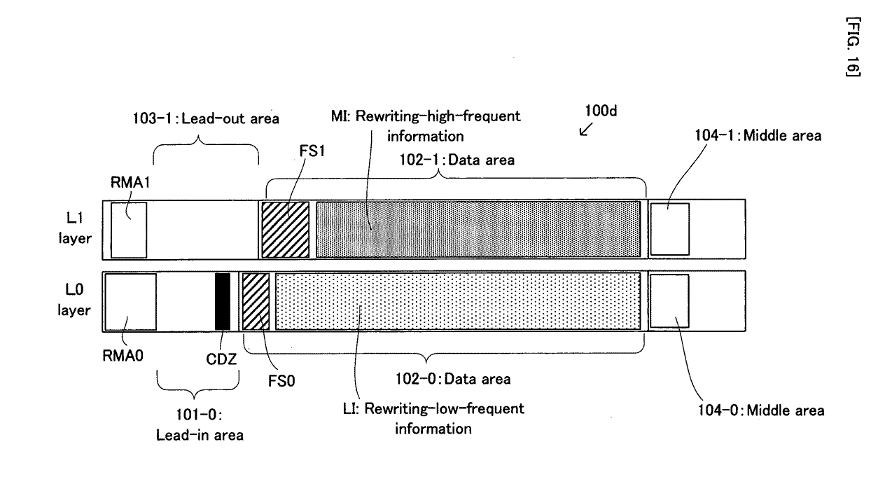

Next, with reference to FIG. 16, an information recording medium in a sixth embodiment of the present invention will be discussed. FIG. 16 is a schematic diagram conceptually showing the data structure of a dual-layer optical disc in the sixth embodiment of the information recording medium of the present invention. Incidentally, the structure of the optical disc in the sixth embodiment, and the recording or reproducing method are substantially the same as those in the first embodiment. Thus, the same elements carry the same numerical references, and the explanation thereof will be omitted.

In an optical disc 100d in the sixth embodiment, as shown in FIG. 16, rewriting-high-frequent information MI, whose rewriting frequency is relatively high, such as map information in a car navigation system, is recorded in the L1 layer. In addition, rewriting-low-frequent information LI, whose rewriting frequency is relatively low, such as application software information in a car navigation system, is recorded in the L0 layer.

As a result, a quantitatively and qualitatively preferable correlation can be maintained between (i) the number of rewriting times determined on the basis of the logical attribute and characteristics in the record data with a large amount of information, and (ii) the number of rewriting times determined on the basis of the physical properties in the first or second recording layer in which the record data is supposed to be recorded.

According to the aforementioned embodiments, in the information recording medium, such as an optical disc, the file system FS1 whose rewriting frequency is relatively high is recorded in the L1 layer. In addition, the file system FS0 whose rewriting frequency is relatively low is recorded in the L0 layer. Consequently, for example, the number of times of actually recording the record data into one kind of recording layer can further approach the number of rewriting times determined on the basis of the physical properties. Moreover, it is possible to take maximum advantage of the physical properties in the first or second recording layer of the information recording medium, to thereby use the recording area in the first or second recording layer, more efficiently.

In the aforementioned embodiments, an explanation was given on the dual-layer optical disc on which recording or reproduction can be performed by using laser light, such as blue ray and red LD light, as one specific example of the information recording medium. In addition, the present invention can be also applied to a multilayer type (multiple layer type) optical disc provided with three or more recording layers, for example. Moreover, it can be also applied to other various information recording media supporting high-density recording or high transfer rate.

Moreover, in the aforementioned embodiments, an explanation was given on the information recording/reproducing apparatus compatible with the dual-layer type optical disc, for example, as one specific example of the information recording apparatus, the information reproducing apparatus, and the information recording/reproducing apparatus. In addition, the present invention can be also applied to an information recording/reproducing apparatus compatible with the multilayer type (multiple layer type) optical disc provided with three or more recording layers, for example. Moreover, it can be also applied to an information recording/reproducing apparatus compatible with other various information recording media supporting high-density recording or high transfer rate.

The present invention is not limited to the aforementioned embodiments, and various changes may be made, if desired, without departing from the essence or spirit of the invention which can be read from the claims and the entire specification. An information recording medium, an information recording apparatus and method, an information reproducing apparatus and method, an information recording/reproducing apparatus and method, and a computer program, all of which involve such changes, are also intended to be within the technical scope of the present invention.

### INDUSTRIAL APPLICABILITY

The information recording medium, the information recording apparatus and method, the information reproducing apparatus and method, and the computer program according to the present invention can be applied to an information recording medium, such as a DVD and a BD, and can be further applied to an information recording apparatus, an information reproducing apparatus or the like, such as a DVD recorder or player. Moreover, they can be applied to an information recording apparatus, an information reproducing apparatus, or the like, which is mounted on various computer equipment for consumer use or for business use, or which can be connected to various computer equipment.

1. An information recording medium, at least comprising:
a first recording layer in which a first portion of record data can be recorded and which has such a property that a limit frequency of rewriting the record data per unit area of a recording area corresponds to a first frequency; and
a second recording layer in which a second portion of the record data can be recorded by using laser light transmitted through the first recording layer and which has such a property that a limit frequency of rewriting the record data per unit area of the recording area corresponds to a second frequency, which is greater than the first frequency, wherein
rewriting-high-frequent information of the record data, whose frequency of rewriting is relatively higher than the frequency of rewriting of the record data, can be recorded at least into the second recording layer.

2. The information recording medium according to claim 1, wherein the rewriting-high-frequent information can be rewritten by the number of rewriting times which is greater than the first frequency.

3. The information recording medium according to claim 1, wherein control information for controlling a recording order or reproduction order of the record data can be recorded into the second recording layer, as the rewriting-high-frequent information.

4. The information recording medium according to claim 3, wherein the control information includes information about directory, which logically hierarchically indicates a position of the record data recorded in the recording area.

5. The information recording medium according to claim 3, wherein the control information includes pointer information, which indicates a position of an end edge of the record data recorded in the recording area.

6. The information recording medium according to claim 3, wherein the control information can be recorded into a control information recording area, which is located on an inner circumferential side or outer circumferential side, adjacent to a position of an end edge of the record data recorded in the second recording layer.

7. The information recording medium according to claim 1, wherein control information for controlling a recording order or reproduction order of the record data can be recorded in a control information recording area with a predetermined recording capacity, in the second recording layer, as the rewriting-high-frequent information.

8. The information recording medium according to claim 1, wherein rewriting-low-frequent information of the record data, whose number of rewriting times is relatively low, can be recorded into the first recording layer.

9. The information recording medium according to claim 8, wherein the rewriting-low-frequent information can be rewritten by the number of rewriting times which is less than the first frequency.

10. The information recording medium according to claim 1, wherein rewriting-low-frequent information of the record data, whose number of rewriting times is relatively low, can be recorded in advance in the first recording layer, by formation of embossed pits.

11. The information recording medium according to claim 1, wherein among control information for controlling a recording order or reproduction order of the record data, attribute information or an entry point can be recorded into the first recording layer, the attribute information indicating an attribute of the control information, the entry point indicating a position of a start edge of the record data recorded in the recording area by using a logical or physical address.

12. The information recording medium according to claim 1, further comprising a management area in which identification information can be recorded, wherein the identification information indicates whether or not control information for controlling a recording order or reproduction order of the record data is recorded into the second recording layer.

13. The information recording medium according to claim 1, wherein control information for controlling a recording order or reproduction order of the record data includes management information for logically continuously recording or reproducing one portion of the control information, which is recorded in the first recording layer, and another portion of the control information, which is recorded in the second recording layer.

14. The information recording medium according to claim 1, wherein a layer thickness of the second recording layer is greater than a layer thickness of the first recording layer.

15. The information recording medium according to claim 1, wherein
the first recording layer has a first reflective layer,
the second recording layer has a second reflective layer, and
a layer thickness of the second reflective layer is greater than a layer thickness of the first reflective layer.

16. An information recording apparatus for recording record data onto an information recording medium, at least comprising: a first recording layer in which a first portion of the record data can be recorded and which has such a property that a limit frequency of rewriting the record data per unit area of a recording area corresponds to a first frequency; and a second recording layer in which a second portion of the record data can be recorded by using laser light transmitted through the first recording layer and which has such a property that a limit frequency of rewriting the record data per unit area of the recording area corresponds to a second frequency, which is greater than the first frequency, wherein one portion of control information, (i) whose number of rewriting times is relatively high out of the record information and (ii) which controls a recording order or reproduction order of the record data, can be recorded into the second recording layer, said information recording apparatus comprising:
an obtaining device for obtaining the control information;
a recording device for recording the record data or the control information; and
a controlling device for (iii) controlling said recording device to record the record data on the basis of the obtained control information and (iv) controlling said recording device to record the control information in order to update the control information on the basis of the recording of the record data.

17. An information reproducing apparatus for reproducing record data from an information recording medium, at least comprising: a first recording layer in which a first portion of the record data can be recorded and which has such a property that a limit frequency of rewriting the record data per unit area of a recording area corresponds to a first frequency; and a second recording layer in which a second portion of the record data can be recorded by using laser light transmitted through the first recording layer and which has such a property that a limit frequency of rewriting the record data per unit area of the recording area corresponds to a second frequency, which is greater than the first frequency, wherein one portion of control information, (i) whose number of rewriting times is relatively high out of the record information and (ii) which controls a recording order or reproduction order of the record data, can be recorded into the second recording layer, said information reproducing apparatus comprising:
an obtaining device for obtaining the control information;
a reproducing device for reproducing the record data or the control information; and
a controlling device for (iii) controlling said reproducing device to reproduce the record data on the basis of the obtained control information

18. An information recording method in an information recording apparatus comprising a recording device for recording record data or control information onto an information recording medium, at least comprising: a first recording layer in which a first portion of the record data can be recorded and which has such a property that a limit frequency of rewriting the record data per unit area of a recording area corresponds to a first frequency; and a second recording layer in which a second portion of the record data can be recorded by using laser light transmitted through the first recording layer and which has such a property that a limit frequency of rewriting the record data per unit area of the recording area corresponds to a second frequency, which is greater than the first frequency, wherein one portion of the control information, (i) whose number of rewriting times is relatively high out of the record information and (ii) which controls a recording order or reproduction order of the record data, can be recorded into the second recording layer, said information recording method comprising:
an obtaining process of obtaining the control information; and
a controlling process of (iii) controlling said recording device to record the record data on the basis of the obtained control information and (iv) controlling said recording device to record the control information in order to update the control information on the basis of the recording of the record data.

19. An information reproducing method in an information reproducing apparatus comprising a reproducing device for reproducing record data or control information from an information recording medium, at least comprising: a first recording layer in which a first portion of the record data can be recorded and which has such a property that a limit frequency of rewriting the record data per unit area of a recording area corresponds to a first frequency; and a second recording layer in which a second portion of the record data can be recorded by using laser light transmitted through the first recording layer and which has such a property that a limit frequency of rewriting the record data per unit area of the recording area corresponds to a second frequency, which is greater than the first frequency, wherein one portion of the control information, (i) whose number of rewriting times is relatively high out of the record information and (ii) which controls a recording order or reproduction order of the record data, can be recorded into the second recording layer, said information reproducing method comprising:
an obtaining process of obtaining the control information; and
a controlling process of (iii) controlling said reproducing device to reproduce the record data on the basis of the obtained control information

20. A computer program for recording control to control a computer provided for the information recording apparatus according to claim 16, said computer program making the computer function as at least one portion of said obtaining device, said recording device, and said controlling device.

21. A computer program for reproduction control to control a computer provided for the information reproducing apparatus according to claim 17, said computer program making the computer function as at least one portion of said obtaining device, said reproducing device, and said controlling device.
